(19) United States
(12) Patent Application Publication
(10) Pub. No.: US 2020/0244300 A1
(43) Pub. Date: Jul. 30, 2020

(54) Mobile Device Carrier

(71) Applicant: Danyelle Nicole Wolf, San Diego, CA (US)

(72) Inventor: Danyelle Nicole Wolf, San Diego, CA (US)

(21) Appl. No.: 16/746,885

(22) Filed: Jan. 19, 2020

Related U.S. Application Data
(60) Provisional application No. 62/798,349, filed on Jan. 29, 2019.

(51) Int. Cl. H04B 1/3888; A45C 13/00; A45C 13/02

(52) U.S. Cl. CPC H04B 1/3888; A45C 2011/002; A45C 13/02; A45C 13/002

(57) ABSTRACT

A mobile device carrier comprising a device pouch and a strap is disclosed. The device pouch is constructed of a compression fit material and sized to receive a mobile device while a portion of the mobile device extends through the opening and remains outside of the device pouch. The compression fit material creates tension on the surface of the mobile device to hold the mobile device in the device pouch with the end of a mobile device remaining outside of the device pouch.

### CROSS-REFERENCE TO RELATED APPLICATIONS

This application claims priority from U.S. Provisional Application 62/798,349, filed Jan. 29, 2019, and titled “Mobile Device Carrier.”

### FIELD OF THE DISCLOSURE

This application relates to mobile device carriers. More specifically, the invention pertains to mobile device carriers constructed to carry mobile devices on a person.

### BACKGROUND

Consumers use mobile device carriers to hold and transport mobile devices. Mobile device carriers come in many different forms including pouches and sleeves and can be used for a variety of different purposes. When choosing a mobile device carrier, users look to factors such as the functionality, protection, transportability, durability, and convenience elements of the mobile device carrier.

Mobile device carriers allow the user to carry the mobile device in a multitude of ways. Some mobile device carriers attach to the user's belt. Other mobile device carriers allow for the user to carry the mobile device over the shoulder, on the wrist, or across the body. Mobile device carriers typically completely enclose the mobile device, requiring the user to open an enclosing mechanism and take the mobile device out of the mobile device carrier in order to use it. Consumers may grow frustrated when mobile device carriers do not allow the user to easily remove the phone in a hurry.

Consumers also consider security when choosing a mobile device carrier. Many mobile phone carriers are bulky and do not allow the user to easily conceal the mobile device. Consumers desire to have the mobile device at a position on their body that makes the mobile device easily accessible in the case of an urgent phone call. But consumers also want to keep the mobile device in a secure location to avoid losing it and to avoid theft.

Many mobile device carriers are designed for a specific purpose, such as athletic activities. Mobile device carriers used in athletic activities allow the user to keep the mobile device on his or her person without it getting in the way of the activity. It is also important that the mobile device be easily accessible during this time and that the mobile device not fall out of the mobile device carrier.

### SUMMARY

Described here is a device for carrying a mobile device on the body of a human. The device includes a device pouch that is substantially rectangular in shape with three closed sides and an opening. The device pouch is constructed of a compression-fit material and is sized to receive a mobile device through the opening. The device pouch holds the mobile device securely in place where a portion of the mobile device extends through the opening and remains outside of the pouch. The device pouch creates tension around the surface of the mobile device as the material at the opening compresses against the mobile device. The device also includes a strap that is connected to the mobile device in a manner that allows a user to wear the pouch on the body.

In some embodiments, the opening contains a form-retaining band that may be constructed from an elastic material to hold the opening in an open position. In some embodiments, the device strap contains a strap adjuster that allows users to adjust the length of the strap. In other embodiments, the device strap extends past the opening along the outer perimeter of the device pouch to add rigidity and protection for a mobile device housed inside the device pouch. Some embodiments of the device also include a storage pouch that allows the user to store small personal items. In certain embodiments, the strap contains a strap opening that is constructed for hanging small personal items or mobile device accessories from the strap. In some embodiments, the device further contains connection openings that allow for the connection of the mobile device to mobile device accessories. Some embodiments allow for a transparent surface for user interaction and viewing of the mobile device surface. In some embodiments, the compression fit material consists of a spandex-type material such as Lycra®.

### BRIEF DESCRIPTIONS OF THE FIGURES

The novel features of this invention, as well as the invention itself, both as to its structure and its operation, will be best understood from the accompanying drawings, taken in conjunction with the accompanying description.

FIG. 1 illustrates a front view of an exemplary embodiment of a mobile device carrier.

FIG. 2a illustrates a front view of an exemplary embodiment of a mobile device carrier with a storage pouch and a strap along the outer perimeter of a device pouch.

FIG. 2b illustrates a front view of an exemplary embodiment of a mobile device carrier with a storage pouch and with a strap looping through an opening on each side of a mobile device pouch.

FIG. 3 illustrates an angled view of an exemplary embodiment of a mobile device carrier with a storage pouch.

FIG. 4 illustrates a front view of an exemplary embodiment of a mobile device carrier and a mobile device.

FIG. 5 illustrates a top view of an exemplary embodiment of a mobile device carrier and a mobile device.

FIG. 6 illustrates a bottom view of an exemplary embodiment of a mobile device carrier with connection openings.

FIG. 7 illustrates a front view of an exemplary embodiment of a mobile device carrier with a strap opening.

FIG. 8 illustrates a front view of an exemplary embodiment of a mobile device carrier with a transparent surface.

FIG. 9 illustrates a front view of an exemplary embodiment of a mobile device carrier with a transparent surface and a mobile device seen through the transparent surface.

FIG. 10 illustrates a frontal exploded view of an exemplary embodiment of a mobile device carrier with a transparent surface on one side, and a strap running around the outer perimeter of the mobile device carrier.

### DETAILED DESCRIPTION

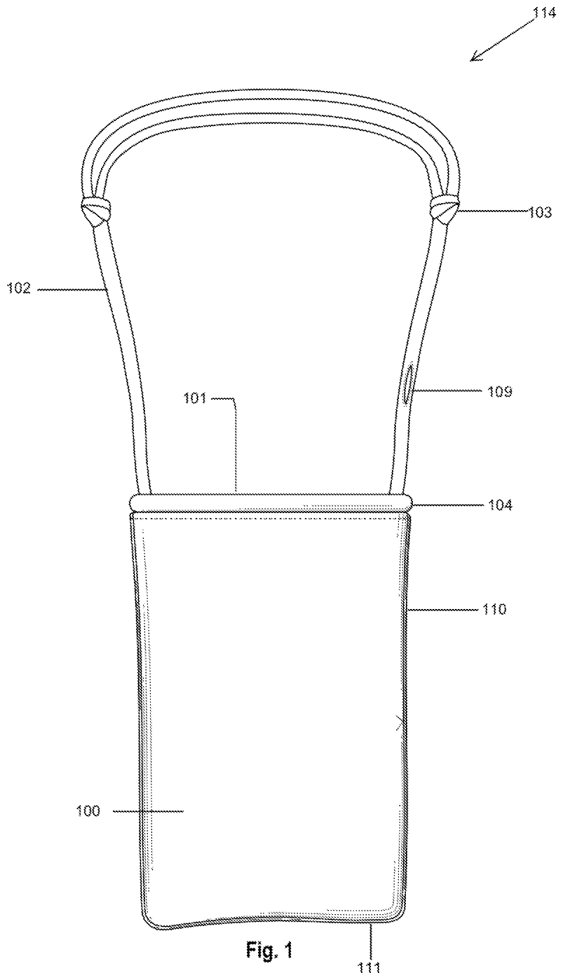

FIG. 1 shows a front view of a mobile device carrier 114. The mobile device carrier 114 contains a device pouch 100 that is sized to receive a mobile device with three closed sides and is constructed to receive the mobile device through an opening 101. In some embodiments, the opening 101 contains a form-retaining band 104 that allows the opening 101 to retain an open shape when the mobile device is not inside the device pouch 100. The device pouch 100 is constructed of compression-fit material that compresses around the mobile device 107 in order to keep the mobile device in the device pouch 100 during various vigorous exercises. The device pouch 100 also contains a closed bottom 111.

In some embodiments, the mobile device carrier 114 contains a strap 102 looped around the opening 101 that allows the user to wear the mobile device carrier 114 on the body in multiple ways, such as around the neck, over the shoulder, and across the body, or under the arm. In some embodiments, the strap 102 contains a strap adjuster 103, such as sliding knots, buckles, or clips, to allow the user to adjust the length of the strap 102. Other adjustment mechanism, such as buckles or clips may also be used to adjust the length of the strap. The strap adjuster 103 further allows for versatility as the user can wear the mobile device carrier around the neck for easy accessibility or under the arm to conceal it and protect it during exercise. The strap 102 extends to at least five times the size of the opening of the device pouch 100.

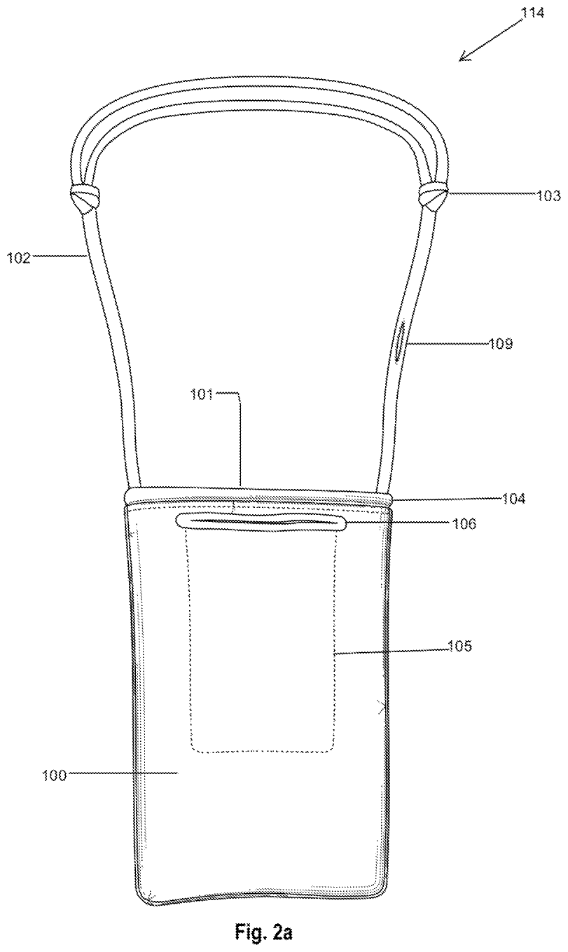

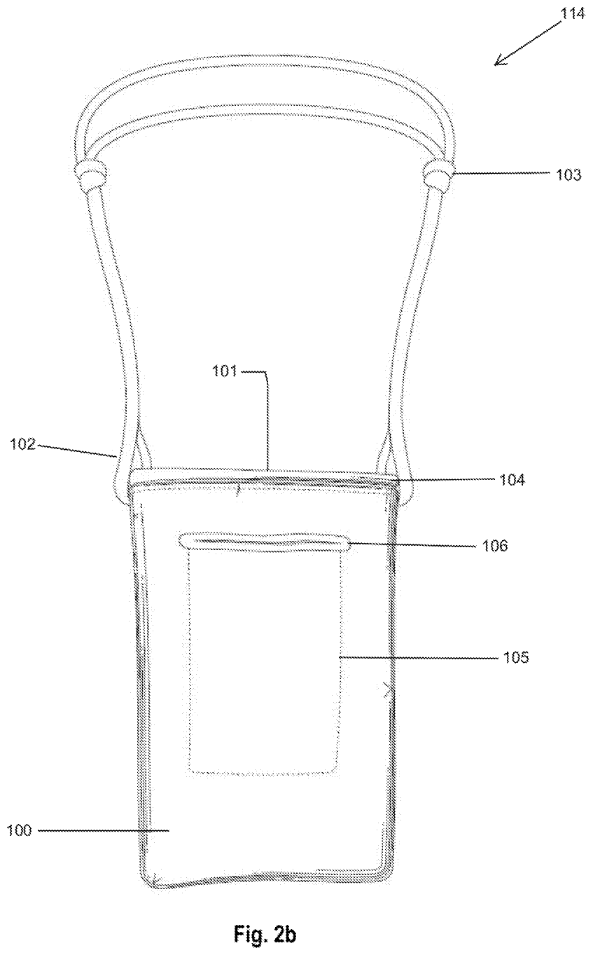

FIG. 2a shows a front view of a mobile device carrier 114. In some embodiments, the mobile device carrier 114 includes a storage pouch 105 that is sized to fit small personal items such as cards, cash, and keys. The storage pouch 105 is accessed through the storage pouch opening 106. In some embodiments, the device pouch 100 is reversible allowing the user to conceal the storage pouch 105 inside of the device pouch 100. It may be desirable for the user to conceal the storage pouch 105 to allow the user to conceal valuable possessions such as bankcards and cash inside the device pouch 100.

In some embodiments, the compression-fit material of the device pouch 100 is comprised of two opposing pieces of material constructed to make the device pouch 100 reversible. In some embodiments, the front and back sides of the device pouch 100 are constructed from one piece of material. The two sides are then constructed of a separate piece of fabric each.

In some embodiments, the mobile device carrier 114 contains the strap 102 that extends past the form-retaining band 104 along the outer perimeter of the device pouch 100 between the two opposing pieces of material to add rigidity to the device pouch 100 and add protection to the mobile device 107. In other embodiments, the strap 102 is connected to the device pouch 100 on either the inside or outside of the device pouch 100. In other embodiments, the strap 102 attaches to the device pouch 100 by looping through an opening under the form-retaining band 104 on each side of the device pouch 100, and then the strap 102 is stitched to itself.

In some embodiments, the strap 102 is constructed of the same compression-fit material as the device pouch 100. In other embodiments, the strap 102 is constructed from a different type of material than the device pouch 100.

In some embodiments, the strap 102 is constructed of two separate ropes, such as in the embodiment shown in FIG. 2a with the sliding knot strap adjuster 103. In some embodiments, each separate rope is about 19 inches long and 0.25 inches wide, but other embodiments allow for a variety of lengths between 12 and 36 inches.

FIG. 2b shows a front view of a mobile device carrier 114. In other embodiments, the strap 102 attaches to the device pouch 100 by looping through an opening under the form-retaining band 104 on each side of the device pouch 100, and then the strap 102 is stitched to itself.

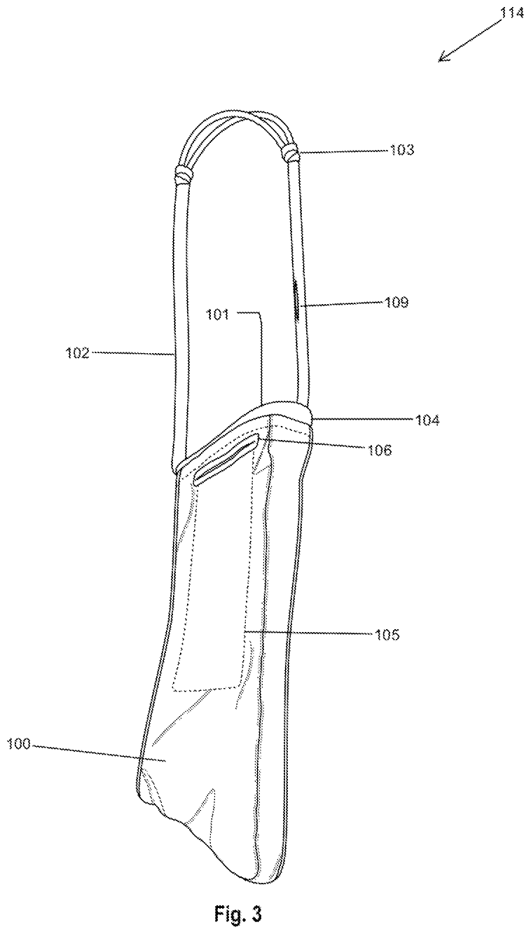

FIG. 3 shows an angled view of a mobile device carrier 114. In some embodiments, the device pouch 100 includes the storage pouch 105 that is sized to fit small personal items such as cards, cash, and keys. The storage pouch 105 is accessed through the storage pouch opening 106. In some embodiments, the device pouch 100 is reversible allowing the user to conceal the storage pouch 105 inside of the device pouch 100. It may be desirable for the user to conceal the storage pouch 105 to allow the user to conceal valuable possessions such as bankcards and cash inside the device pouch 100.

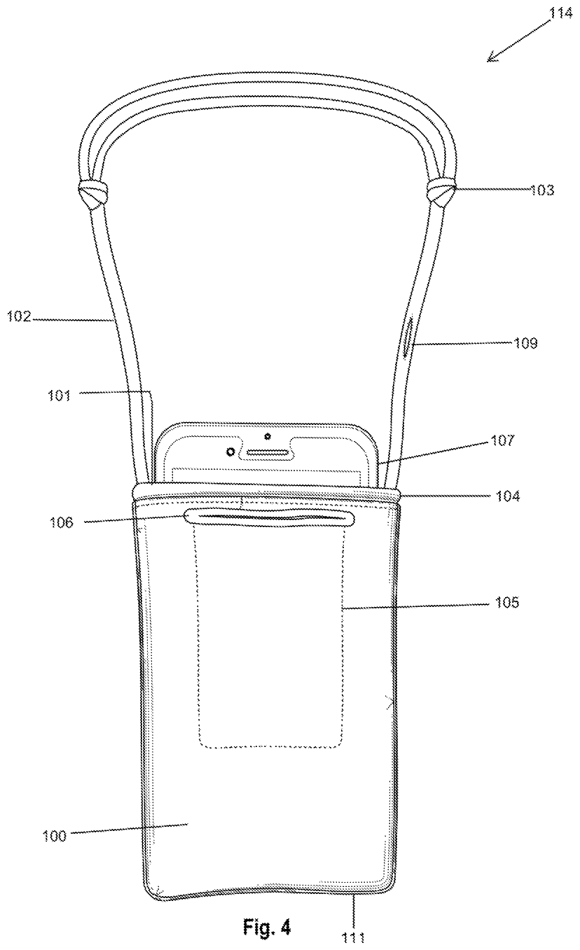

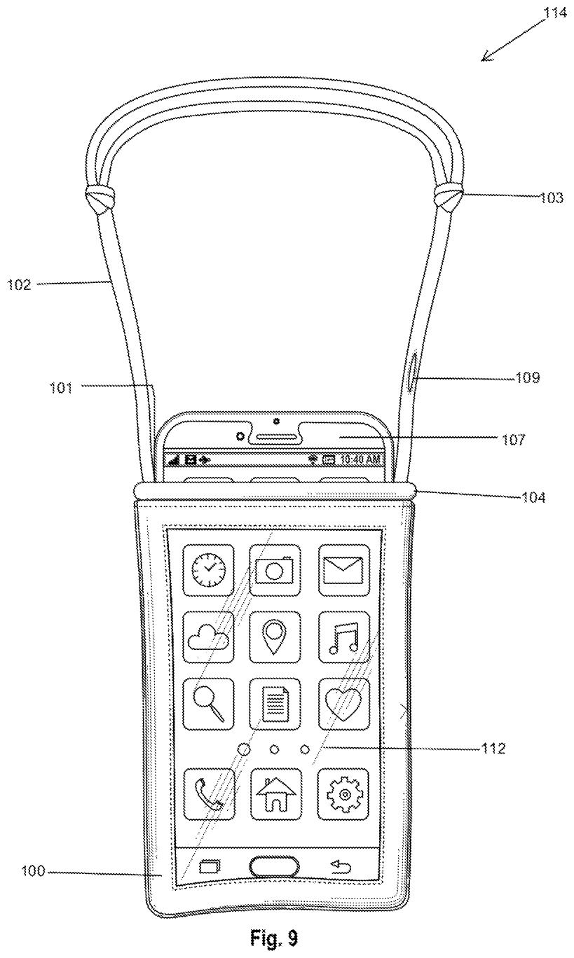

FIG. 4 shows a front view of a mobile device carrier 114 with a mobile device 107 inside the device pouch 100. In some embodiments, the device pouch 100 is sized to fit a mobile device 107 so that the top portion of the mobile device 107 is exposed allowing the user to view notifications on the mobile device 107 without removing the mobile device 107 from the device pouch 100. The device pouch 100 is constructed of a compression-fit material that holds the mobile device 107 inside the device pouch 100 without completely enclosing the mobile device 107 so that the mobile device 107 does not fall out of the device pouch 100 during movement and exercise. Because the compression-fit material of the device pouch 100 holds the mobile device 107 into place during various exercises without fully enclosing the mobile device 107, the user is able to view notifications on the screen of the mobile device 107 through a transparent surface 112, as shown in FIG. 9, and easily remove the mobile device 107 from the device pouch 100 without having to open any of the closing mechanisms on mobile device carriers such as hook and loop fasteners, clips, hooks, or buttons. The compression-fit material fits tightly against the mobile device 107 and prevents the mobile device 107 from falling out of the device pouch 100. The device pouch 100 is constructed with an aspect ratio calculated to hold the mobile device 107 in the device pouch 100 without the mobile device 107 falling out of the device pouch.

For example, in some embodiments, the device pouch measure 3.75 inches×2.5 inches for a mobile device sized 4.87 inches×2.31 inches. This allows for a tight fit around the edges of the mobile device 107 thereby preventing it from falling out of the device pouch 100 during activities. The ratio of the device pouch 100 is approximately 3:2 for a mobile phone with an aspect ratio of approximately 49:23 and could fit a mobile device with an aspect ratio of approximately 2:1. For a mobile device 107 sized about 4.5×2 inches and 5 by 2.5 inches, the device pouch 100 must be sized to about 3.75 by 2.5 inches in order to provide sufficient tension around the mobile device 107 to keep the mobile device 107 inside the device pouch 100. The opening 101 has a predetermined mobile device sized perimeter and is constructed to receive a mobile device. The device pouch 100 creates a first tension around the opening 101 of the device pouch 100 and a second tension, greater than the first tension, around the predetermined mobile device sized perimeter of the opening 101. The closed bottom 111 of the device pouch 100 extends to ¾ of a predetermined mobile phone sized depth. And, the closed bottom 111 experiences the first tension from the opening 101.

The compression fit material is constructed to allow the device pouch 100 to fit around the mobile device 107 even when the width of the device pouch 100 is slightly smaller than the width of the mobile device 107. The compression-fit material of the device pouch 100 is designed to fit tightly against the mobile device 107 inside the device pouch 100. The compression-fit material is designed to hold the mobile device 107 securely into place, with a portion of the mobile device 107 extending through the opening 101 of the device pouch 100. The compression-fit material creates tension around the surface of the mobile device 107 in order to secure the mobile device 107 into place during various vigorous exercises. The compression-fit material consists of spandex-type material such as Lycra®.

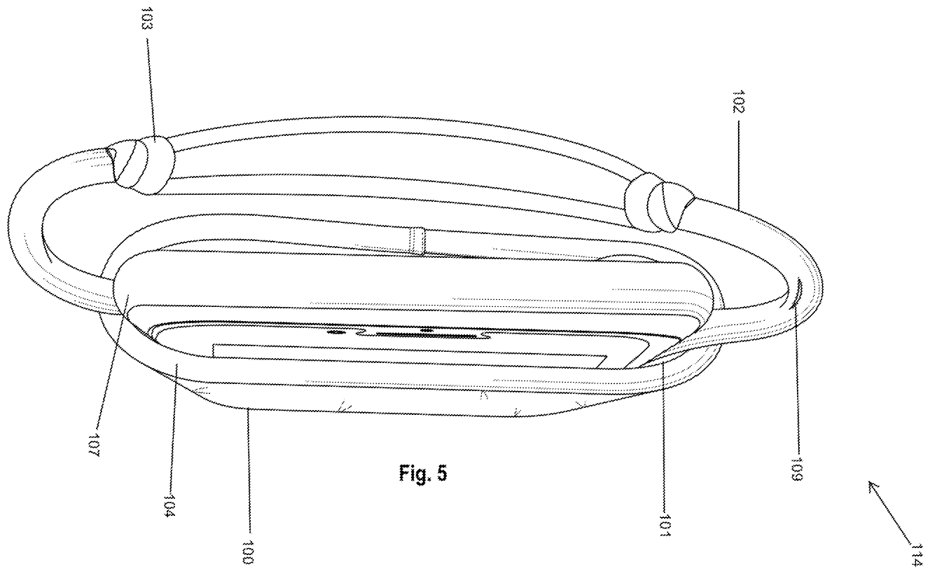

FIG. 5 shows a top view of a mobile device carrier 114 with a mobile device 107 inside the device pouch 100. In some embodiments, the device pouch 100 contains a form-retaining band 104, which holds the device pouch 100 open when a mobile device 107 is not inside the device pouch 100. In some embodiments, the form-retaining band 104 allows the user to easily insert a mobile device 107 into the device pouch 100 without having to hold the opening 101 in an open position. The form-retaining band 104 allows for easy insertion and removal of the mobile device 107 to and from the device pouch 100 and therefore allows for easy access to the mobile device 107.

In some embodiments, the form-retaining band 104 is constructed from an elastic material that allows the opening 101 to remain in an open position and stretch around the mobile device 107 and fits more tightly against the mobile device 107 than the compression-fit material. The form-retaining band 104 both secures the mobile device 107 into place and allows the device pouch 100 to retain an open position.

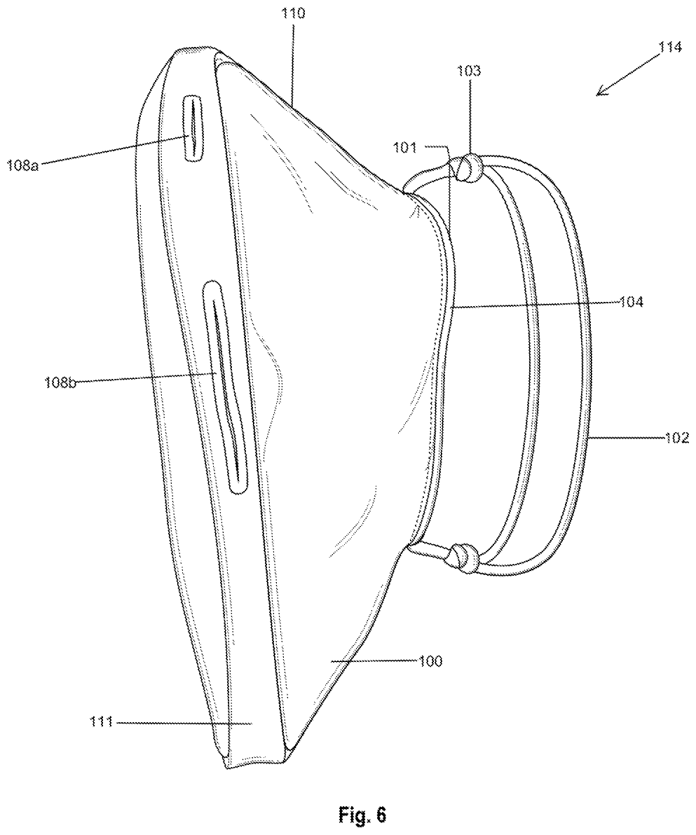

FIG. 6 shows a bottom view of a mobile device carrier 114. In some embodiments, the device pouch 100 contains one or more connection openings which allow for connection of the mobile device 107 to connecting accessories such as chargers and headphones. In some embodiments, a connection opening 108a is located in the closed bottom 111 for connecting headphones 113. Also, a connection opening 108b is located in the closed bottom 111 for connecting mobile device chargers. The two connection openings 108a and 108b are located at the ports for connection on the mobile device 107 and are sized to fit standard connecting accessories.

In some embodiments, the construction of the back and front of the device pouch 100 from one piece of material allows for easy access to the connection ports of the mobile device 107 via the connection openings 108a and 108b because there is no seam at the bottom of the device pouch 100.

In some embodiments, the device pouch contains a protective lining 110 around the outside edge of the device pouch 100 that allows for protection of the phone against impacts. In some embodiments, the protective lining 110 comprises a cushioned material that protects the edges of the mobile device 107 from an impact from a bump against a hard service or a drop.

In some embodiments, the device pouch 100 contains the transparent surface 112 located on the front side of the device pouch 100 and placed in the same area as the screen on the mobile device 107 allowing for user interaction and viewing of the surface of the mobile device 107. Even with the transparent surface, the exposure of the top of the mobile device serves the purpose of allowing the user to easily remove the mobile device 107 from the device pouch 100.

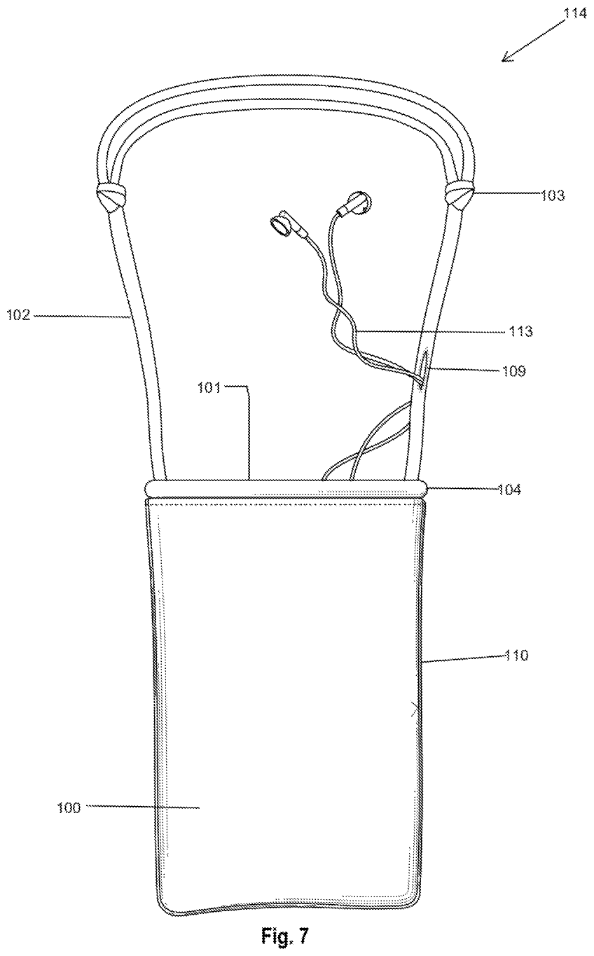

FIG. 7 shows a front view of a mobile device carrier 114. In some embodiments, the strap 102 of the mobile device carrier contains a strap opening 109 that allows the user to hang small items on the strap 102, such as keys or headphones 113. In some embodiments, the strap opening 109 is positioned slightly above the end of the strap 102 where it is connected to the device pouch 100. But, the strap opening 109 can be positioned at any point along the strap 102. In some embodiments, the strap opening 109 is sized as a slit at about 0.875 inches in length and sized to fit a standard keyring, carabiner, or headphone cord. Some embodiments of the invention contain multiple strap openings 109 for connection to multiple accessories or personal items.

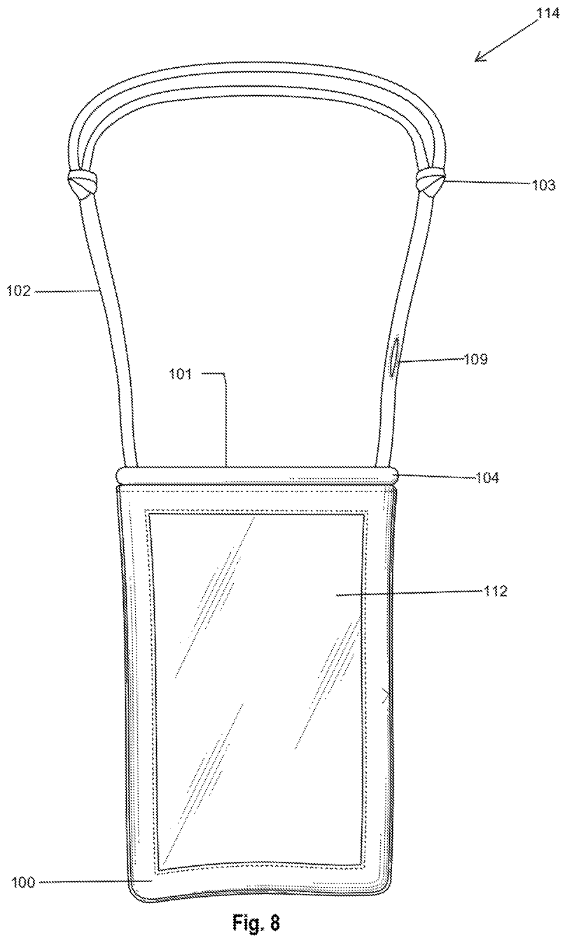

FIG. 8 shows a front view of a mobile device carrier 114. In some embodiments, the transparent surface 112 is located on the front side of the device pouch 100 and placed in the same area as the screen on the mobile device allowing for user interaction and viewing of the surface of the mobile device. Even with the transparent surface 112, the exposure of the top of the mobile device serves the purpose of allowing the user to easily remove the mobile device from the device pouch 100.

FIG. 9 shows a front view of a mobile device carrier 114. In some embodiments, the transparent surface 112 is located on the front side of the device pouch 100 and placed in the same area as the screen on the mobile device 107 allowing for user interaction and viewing of the surface of the mobile device 107. Even with the transparent surface 112, the exposure of the top of the mobile device serves the purpose of allowing the user to easily remove the mobile device 107 from the device pouch 100.

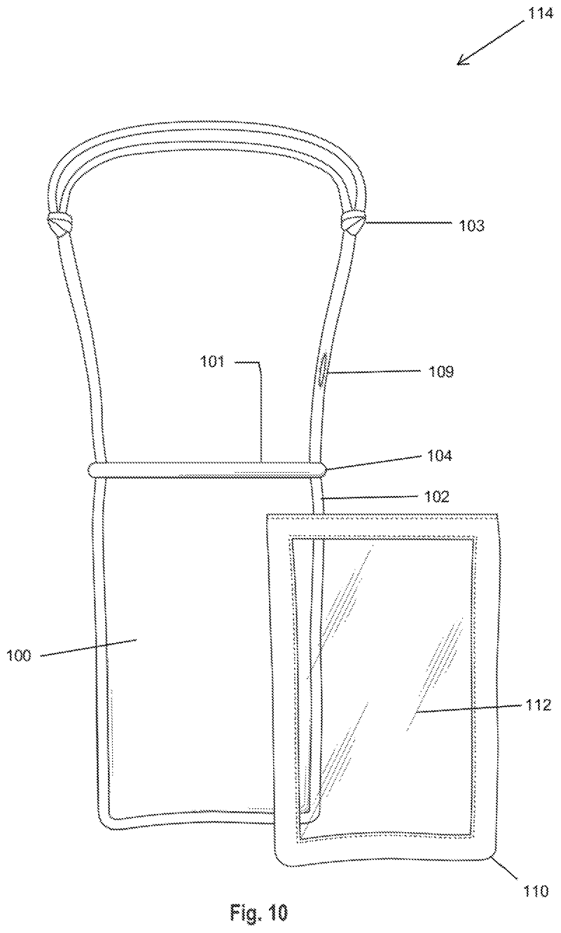

FIG. 10 shows a frontal exploded view of a mobile device carrier 114. In some embodiments, the mobile device carrier contains the strap 102 that extends past the form-retaining band 104 along the outer perimeter of the device pouch 100 to add rigidity to the device pouch 100 and add protection to the mobile device from physical impacts. As shown in this figure, the strap 102 is stitched between the front side and back side of the device pouch 100.

Spatially relative terms, such as “bottom,” “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

While the invention has been described here in terms one or more preferred embodiments, it will be apparent to those skilled in the art that various changes and modifications can be made to those embodiments, and other embodiments altogether can be used to carry out the invention, without departing from the scope and spirit of the invention.

What is claimed is:

1. A device pouch comprising:
an opening comprising a predetermined mobile device sized perimeter;
a strap that extends past the opening along a perimeter of the device pouch, wherein the strap is at least five times longer than the opening; and
a closed bottom extending to ¾ of a predetermined mobile device sized depth, wherein:
the closed bottom is configured to experience a first tension from the opening,
the opening is configured to experience a second tension around the predetermined mobile device sized perimeter greater than the first tension, and
the device pouch is constructed of a compression fit material.

2. The device pouch of claim 1, wherein the opening comprises a form-retaining band constructed to hold the opening in an open position.

3. The device pouch of claim 2, wherein the form-retaining band consisting of an elastic material.

4. The device pouch of claim 2, wherein the form-retaining band is constructed to fit more tightly against a mobile device than the compression fit material of the device pouch.

5. The device pouch of claim 1, wherein the strap comprises a strap adjuster constructed to allow a user to adjust a length of the strap.

6. The device pouch of claim 1, wherein the device pouch comprises a storage pouch comprising a storage pouch opening sized to hold small personal items.

7. The device pouch of claim 6, wherein the device pouch is reversible and allows for concealing the storage pouch inside the device pouch.

8. The device pouch of claim 1, wherein the compression fit material consists of a spandex-type material.

9. The device pouch of claim 1, wherein the device pouch comprises one or more connection openings allowing for a connection of a mobile device to mobile device accessories while the mobile device remains inside the device pouch.

10. The device pouch of claim 1, wherein the strap comprises at least one strap opening for hanging of mobile device accessories or other small personal items.

11. The device pouch of claim 1, wherein the device pouch comprises a transparent surface allowing for user interaction and viewing of a surface of a mobile device.

12. The device pouch of claim 1, wherein the device pouch measures 3.75 inches×2.5 inches to fit a mobile device sized between 4.5 inches by 2 inches and 5 inches by 2.5 inches.

13. The device pouch of claim 1, wherein the strap is constructed from the compression fit material.

14. The device pouch of claim 1, wherein a front side and a back side of the device pouch are constructed from one piece of material, and a first and second side are constructed from two separate pieces of material.

15. The device pouch of claim 1, wherein the device pouch further comprises a protective lining positioned along an edge of the device pouch and constructed to protect a mobile device from an impact.

16. A device comprising:
a device pouch that is constructed of a compression-fit material and sized to receive a mobile device through an opening,
a strap connected to the device pouch in a manner that allows the device pouch to be worn on a body,
a form-retaining band constructed to hold the opening in an open position,
a strap adjuster constructed to allow a user to adjust a length of the strap,
a storage pouch comprising a storage pouch opening sized to hold small personal items,
one or more connection openings allowing for a connection of the mobile device to mobile device accessories.

17. The device of claim 16, wherein the device pouch measures 3.75 inches×2.5 inches to fit the mobile device between 4.5 inches by 2 inches and 5 inches by 2.5 inches.

18. The device of claim 16, wherein the device pouch further comprises a transparent surface allowing for user interaction and viewing of a surface of the mobile device.

19. The device of claim 16, wherein the form-retaining band is constructed of an elastic material.

20. The device of claim 16, wherein the device pouch further comprises a protective lining positioned along an edge of the device pouch and constructed to protect the mobile device from an impact.
